(19) United States
(12) Patent Application Publication
(10) Pub. No.: US 2011/0067568 A1
(43) Pub. Date: Mar. 24, 2011

(54) APPARATUS AND METHOD FOR MECHANICAL DEAERATION

(75) Inventors: Richard Triglavcanin, Dalkeith (AU); Ian Arbuthnot, Halls Head (AU)

(73) Assignee: OUTOTEC OYJ, Espoo (FI)

(21) Appl. No.: 12/992,884

(22) PCT Filed: May 8, 2009
(86) PCT No.: PCT/AU09/00585

§ 371 Date: Nov. 15, 2010

(30) Foreign Application Priority Data
May 15, 2008 (AU) 2008902417

(51) Int. Cl. B01D 19/00

(52) U.S. Cl. 95/261; 96/216; 96/217

(57) ABSTRACT

The invention provides an apparatus (1) for deaerating a feed liquid (3) comprising a liquid suspension or pulp, the apparatus comprising a feed conduit (2) to convey the feed liquid (3) into a separator (4), the separator (4) comprising a mechanical agitator (5) for inducing a rotational flow of the feed liquid in a separation chamber (6), such that the rotational flow generates a centrifugal vortex (15) to separate the feed liquid into a first component (7) consisting essentially of froth or gas and a second component (8) consisting essentially of deaerated liquid or sludge, the separator (4) further comprising a device (17) for controlling the location of the vortex (15) in the separation chamber (6). The invention also provides a method for deaerating a feed liquid (3) comprising a liquid suspension or pulp.

### FIELD OF THE INVENTION

The present invention relates to deaerating liquids and in particular to an apparatus and method for deaerating or separating entrained air or froth from liquid suspensions or pulps. It has been developed primarily for use in thickeners, clarifiers, or concentrators and will be described hereinafter with reference to this application. However, it will be appreciated that the invention is not limited to this particular field of use.

### BACKGROUND OF THE INVENTION

The following discussion of the prior art is intended to present the invention in an appropriate technical context and allow its significance to be properly appreciated. Unless clearly indicated to the contrary, however, reference to any prior art in this specification should not be construed as an admission that such art is widely known or forms part of common general knowledge in the field.

Thickeners, clarifiers and concentrators are typically used for separating solids from liquids and are often found in the mining, mineral processing, food processing, sugar refining, water treatment, sewage treatment, and other such industries.

These devices typically comprise a tank in which solids are deposited from suspension or solution and settle toward the bottom as pulp or sludge to be drawn off from below and recovered. A dilute liquor of lower relative density is thereby displaced toward the top of the tank, for removal via an overflow launder. The liquid to be thickened is initially fed through a feed pipe or feed line into a feedwell disposed within the main tank. The purpose of the feedwell is to ensure relatively uniform distribution and to prevent turbulence from the incoming feed liquid from disturbing the settling process taking place within the surrounding tank.

In cases where the feed liquid comprises entrained air, such as flotation concentrate, it is normally at least partially aerated. The air bubbles, if allowed to pass from the feedwell into the main tank, tend to produce a considerable amount of relatively stable froth on the surface of both the feedwell and the thickener. This froth can contain a significant proportion of entrained solids and thereby tends to reduce the separation efficiency of the thickener, and contaminates the dilute liquor. In addition, air bubbles can become trapped in the sludge, resulting in slower settling rates and lower underflow densities, both of which reduce separation efficiency further still. A further problem is that the froth leaves solid particulates in the overflow and these particulates eventually deposit in storage tanks or dams, which consequently must be frequently cleaned to remove accumulated sedimentation and contaminants. The particulates also contaminate the process water for the plant, as the dilute liquor is generally recycled for this use. This increases plant costs in the additional maintenance of the storage tanks or dams, and the removal of solid particulates from the process water.

One solution for this problem has been to provide a deaeration unit for separating froth from the feed liquid before it is fed into the separation device. This deaeration unit has a cyclonic separator, which generates a centrifugal vortex that separates partially aerated liquid into a froth or gas component and a deaerated liquid or sludge component. The froth or gas component is removed from the deaeration unit as an overflow stream while the deaerated liquid or sludge component leaves as an underflow stream that is subsequently fed into the separation device.

Whilst this solution has proved effective in reducing the amount of froth that is generated in the separation device, it has several limitations. First, the partially aerated feed liquid has to be pumped into the unit at high pressure, around 100 kPa, to generate a sufficiently powerful vortex to separate froth from the feed liquid. This means that a pumping system and its associated plumbing is required to be installed and maintained in the plant. Second, the maximum capacity of this deaeration unit is around 80 m³/hr. This places an upper limit on the throughput of feed slurry that can be processed by a single deaeration unit. For example, to process 400 m³, which is a typical amount of feed slurry, five such deaeration units are required.

It has also been found that to increase the capacity of these deaeration units would require a higher flow velocity to generate the vortex, meaning that higher pressure must be generated from the pumping system, rendering such upscaling uneconomical. In addition, using a pump system in the deaeration unit conflicts with many types of separation devices, such as thickeners and clarifiers, which prefer using a gravity feed for the incoming slurry to save on costs in installing and maintaining a pumping system.

It is an object of the invention to overcome or ameliorate one or more of the deficiencies of the prior art, or at least to provide a useful alternative.

### SUMMARY OF THE INVENTION

According to a first aspect of the invention, there is provided an apparatus for deaerating a feed liquid comprising a liquid suspension or pulp, the apparatus comprising a feed conduit to convey the feed liquid into a separator, the separator comprising a mechanical agitator for inducing a rotational flow of the feed liquid in a separation chamber such that the rotational flow generates a centrifugal vortex to separate the feed liquid into a first component consisting essentially of froth or gas and a second component consisting essentially of deaerated liquid or sludge, the separator further comprising a device for controlling the location of the vortex in the separation chamber.

Unless the context clearly requires otherwise, throughout the description and the claims, the words “comprise”, “comprising”, and the like are to be construed in an inclusive sense as opposed to an exclusive or exhaustive sense; that is to say, in the sense of “including, but not limited to”.

Preferably, the vortex locating device controls a start point of the vortex. Preferably, the position of the vortex locating device is adjustable.

Preferably, the vortex locating device has a shape such that its transverse cross-section complements the cross-sectional shape of the separation chamber. Preferably, the vortex locating device is substantially circular. In one preferred form, the vortex locating device is a substantially horizontal circular disc.

Preferably, the mechanical agitator comprises a rotor mounted to a drive shaft and a drive mechanism for rotating the drive shaft so that the rotor induces the rotational flow in the separation chamber.

Preferably, the vortex locating device axially displaces a start point of the vortex from the rotor. Preferably, the vortex locating device is provided adjacent or on the drive shaft. Preferably, the vortex locating device extends substantially perpendicular to the drive shaft. Preferably, the vortex locating device has a diameter equal to or less than diameter of the rotor.

Preferably, the rotation of the rotor defines a shape that substantially complements the cross-sectional shape of the separation chamber.

Preferably, the rotor comprises a plurality of rotor blades. Preferably, the rotor blades are equidistant to each other. Preferably, the rotor blades extend substantially horizontally and vertically in the separation chamber. In one preferred form, the rotor blades define at least one V-shape or U-shape in the vertical plane. In another preferred form, the rotor blades define at least an X-shape in the horizontal plane.

Preferably, the separation chamber is substantially frusto-concial in shape. Alternatively, the separation chamber is substantially cylindrical in shape. In another preferred form, the separation chamber is partly cylindrical and partly conical in shape.

Preferably, the feed conduit is configured to permit a gravity feed of the feed liquid.

Preferably, the first component leaves the separator as an overflow stream. Preferably, the separation chamber comprises an upper outlet for the first component. In one preferred form, the upper outlet is located centrally about the drive shaft. Preferably, the second component leaves the separator as an underflow stream. Preferably, the separation chamber comprises a lower outlet for the second component. The overflow and underflow may be directed to separate downstream process units. More preferably, the underflow stream is directed as a feed stream into a separation device. The separation device is preferably a thickener.

According to a second aspect, the invention provides a method for deaerating a feed liquid comprising a liquid suspension or pulp, the method comprising the steps of conveying the feed liquid into a separation chamber, mechanically agitating the feed liquid to induce a rotational flow, such that the rotational flow generates a centrifugal vortex to separate the feed liquid into a first component consisting essentially of froth or gas and a second component consisting essentially of deaerated liquid or sludge, and controlling the location of the vortex in the separation chamber with a vortex locating device.

Preferably, the vortex locating step comprises controlling a start point of the vortex. Preferably, the vortex locating step comprises adjusting the position of the vortex locating device.

Preferably, the method further comprises the step of forming the vortex locating device such that its transverse cross-section complements the cross-sectional shape of the separation chamber. Preferably, the vortex locating device is substantially circular in shape or is a substantially horizontal circular disc.

Preferably, the mechanical agitating step comprises rotating a rotor about a drive shaft to induce the rotational flow of the feed liquid.

Preferably, the vortex locating step comprises axially displacing a start point of the vortex from the rotor. Preferably, the vortex locating step comprises locating a vortex start point adjacent or on the drive shaft.

Preferably, the method further comprises the step of forming the rotor such that rotation of the rotor defines a shape that substantially complements the shape of the separation chamber.

Preferably, the feeding step comprises feeding the feed liquid under gravity into the separation chamber.

Preferably, the method further comprises the steps of removing the first component as an overflow stream and removing the second component as an underflow stream. Preferably, the method further comprises the step of directing the overflow and underflow streams to separate downstream process units.

Preferably, the method further comprises the step of directing the underflow stream into a separation device. Preferably, the separation device is a thickener

In the preferred embodiments of both aspects, the invention is used for removal of froth and air from a feed slurry before it is fed into a thickener. The thickener preferably comprises a tank in which a dispersed solid component tends to settle from solution or suspension toward a lower region of the tank to be drawn off from below whilst a relatively dilute liquor is thereby displaced toward an upper region of the tank for separation via an overflow launder.

### BRIEF DESCRIPTION OF THE DRAWINGS

Preferred embodiments of the invention will now be described, by way of example only, with reference to the accompanying drawings in which:

FIG. 1 is a cross-sectional view of an apparatus for deaerating a feed liquid according to a first embodiment of the invention;

FIG. 2 is a perspective schematic view of the mechanical agitator used in the deaeration apparatus of FIG. 1;

FIG. 3 is a cross-sectional view of an apparatus for deaerating a feed liquid according to a second embodiment of the invention;

FIG. 4 is a perspective schematic view of the mechanical agitator used in the deaeration apparatus of FIG. 3;

FIG. 5 is a cross-sectional view of an apparatus for deaerating a feed liquid according to a third embodiment of the invention;

FIG. 6 is a cross-sectional view of an apparatus for deaerating a feed liquid according to a fourth embodiment of the invention;

FIG. 7 is a cross-sectional view of an apparatus for deaerating a feed liquid according to a fifth embodiment of the invention; and

FIG. 8 is a perspective schematic view of a mechanical agitator for use in the deaeration apparatus according to the invention.

### PREFERRED EMBODIMENTS OF THE INVENTION

A preferred application of the invention is in the fields of mineral processing, separation and extraction, whereby finely ground ore is suspended as pulp in a suitable liquid medium such as water at a consistency which permits flow, and settlement in quiescent conditions. The pulp is settled from the suspension by a combination of gravity with chemical and/or mechanical processes. The pulp gradually clumps together to form aggregates of larger pulp particles as it descends from the feedwell towards the bottom of the tank. This is typically enhanced by the addition of flocculating agents, also known as flocculants, which bind the settling solid or pulp particles together. These larger and denser pulp aggregates settle more rapidly than the individual particles by virtue of their overall size and density relative to the surrounding liquid, gradually forming a compacted arrangement within a pulp bed at the bottom of the tank.

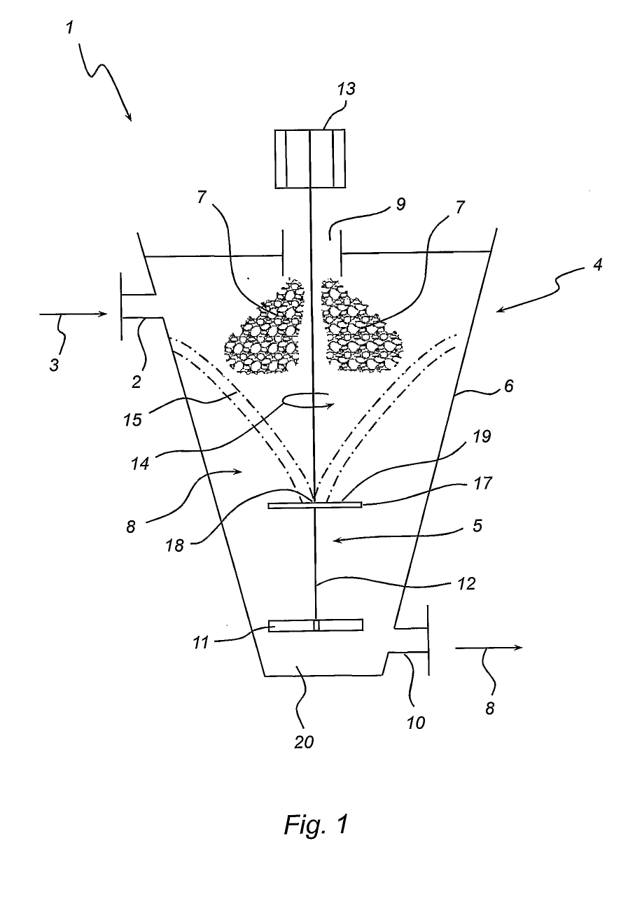

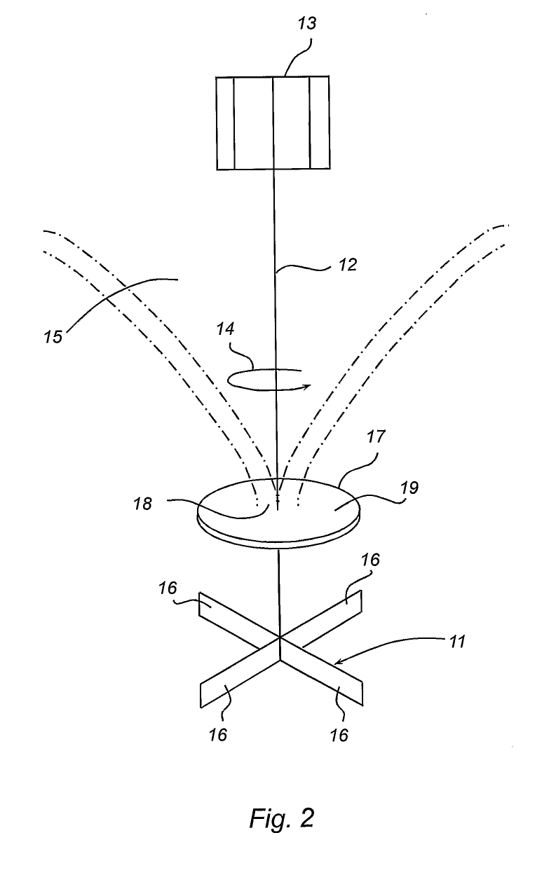

Referring to FIGS. 1 and 2, an apparatus 1 for deaerating a feed liquid comprising suspension or pulp according a first embodiment of the invention is illustrated. The apparatus 1 comprises a feed conduit in the form of an inlet 2 to convey the feed liquid 3 into a centrifugal-type separator 4, which has a mechanical agitator 5 for inducing a rotational flow of the feed liquid in a substantially frusto-conical separation chamber 6. The separator 4 separates the feed liquid 3 into a first component 7 consisting essentially of froth or gas and a second component 8 consisting essentially of deaerated liquid or sludge.

The feed inlet 2 receives the feed liquid 3 by a gravity flow from an upstream process, and may be provided with a valve assembly (not shown) to regulate the flow of the feed liquid. In other embodiments, the feed liquid is pumped through the feed inlet 2 into the apparatus 1. It will also be appreciated by one skilled in the art that instead of a feed inlet, the feed conduit may comprise a feed line, channel (open or closed) or trough upstream of the apparatus 1.

The froth component 7 leaves the separator 4 as an overflow stream through an upper outlet 9 centrally located at the top of the separation chamber 6 while the deaerated component 8 leaves the separator as an underflow stream through a lower outlet 10. The overflow and underflow streams from the separator 4 may be directed to separate downstream process units (not shown).

The mechanical agitator 5 comprises a rotor 11 mounted to a drive shaft 12 and a drive mechanism 13 for rotating the drive shaft (as shown by arrow 14). The rotor 11 induces rotational flow of the feed liquid 3 in the separation chamber 6 to create a centrifugal vortex 15 that separates the feed liquid into the froth component 7 and the deaerated liquid or sludge component 8. The rotor 11 comprises four rotor blades 16 equidistantly spaced to define an X-shape when viewed in the horizontal plane.

A device 17 for controlling the location of the vortex 15 in the separation chamber 6 is provided on the drive shaft 12 in the form of a substantially horizontal disc. The disc 17 locates the vortex 15 so that its start point 18 begins adjacent or on the upper surface 19 of the disc, as best shown in FIG. 2. As a consequence, the vortex 15 is axially displaced above the rotor 11, ensuring that formation of the vortex 15 is controlled and kept confined within an upper portion of the separation chamber 6. This prevents the vortex 15 from extending past the rotor 11 and towards the bottom 20 of the separation chamber 6, which would contaminate the deaerated liquid or sludge component 8 by re-aerating it. The disc 17 extends substantially perpendicular to the drive shaft 12, has a diameter approximately equal to the diameter of the rotor 11 and has a circular transverse cross-section to complement the circular cross-sectional shape of the separation chamber 6.

It will be appreciated that the vortex locating device 17 need only maintain a sufficient distance between the rotor 11 and the start point 18 of the vortex 15 to ensure that the vortex does not extend past the rotor. Thus, the vortex locating device 17 can be positioned axially lower on the drive shaft 12 so that the vortex 15 is not confined in the upper section of the separation chamber 6 but extends further down and occupy more volume of the separation chamber.

Although adjusting the rpm (revolutions per minute) of the rotor 11 could also control the vortex, it will be appreciated that the disc 17 provides a more convenient and efficient means for controlling the location of the vortex 15.

In operation, the feed inlet 2 feeds aerated slurry 3 into the separation chamber 6, preferably tangentially. The drive mechanism 13 and the drive shaft 12 rotate the rotor 11 so as to induce a rotational flow of the slurry 3 that develops into a centrifugal vortex 15 initiating from the vortex locating disc 17. The vortex 15 separates the feed slurry 3 into the froth component 7 and the deaerated liquid or sludge component 8. Due to its lighter density, the froth 7 migrates upwardly in the separation chamber 6 and is removed through the upper outlet 9 as an overflow stream. The deaerated liquid or sludge 8, due to its heavier density, migrates downwardly towards the bottom 20 of the separation chamber 6 and is removed through the lower outlet 10 as an underflow stream.

The centrifugal-type separator 4 is particularly efficient in separating froth from partially aerated pulps by centrifugal forces and/or “shearing” to remove the air bubbles from the solid particles. The proportion of deaeration of the feed liquid can be controlled as appropriate by varying several operating parameters of the centrifugal separator 4, including the diameter of the separator, the separator length, the angle of the separator barrel, the size of the feed conduit, the feed density, throughput of feed liquid into the separator and the speed of rotation of the rotor. With a partially aerated feed liquid, and appropriately tuned operating parameters, a relatively small overflow stream can be produced with the apparatus 1 which contains the vast majority of the froth, leaving a proportionately large volume of deaerated underflow liquid having a density similar to that of the feed liquid.

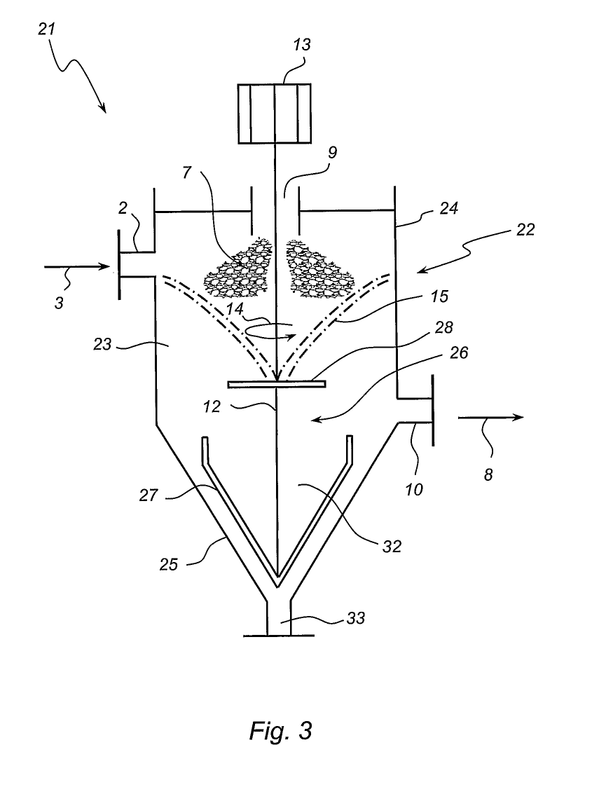

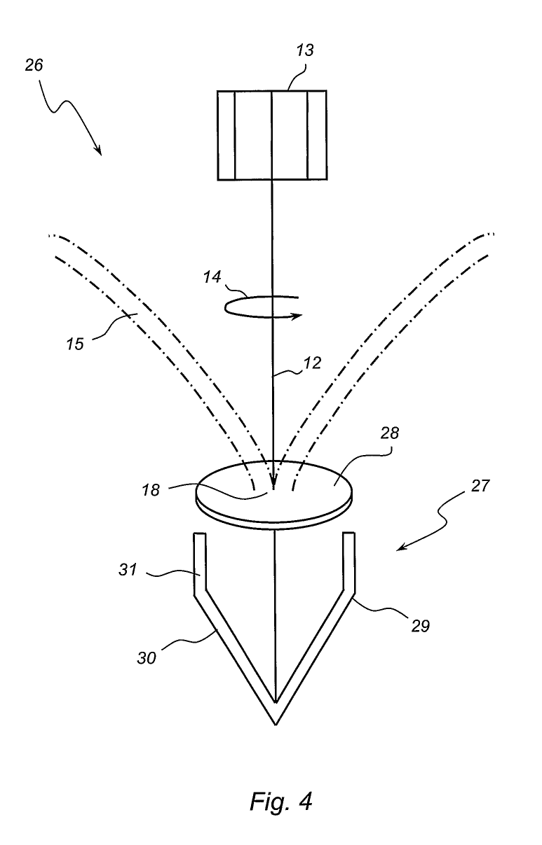

A deaeration apparatus 21 according to a second embodiment of the invention is illustrated in FIGS. 3 and 4, where corresponding features have been given the same reference numerals. In this embodiment, the separator 22 has a separation chamber 23 with an upper cylindrical section 24 and a lower conical section 25. The mechanical agitator 26 has a rotor 27 within the lower conical section 25 and a vortex locating disc 28 axially displaced from the rotor to lie within the upper cylindrical section 24.

Referring FIG. 4, the configuration of the mechanical agitator 26 is shown in more detail. The rotor 27 has two rotor blades 29, each having an angled blade section 30 and a substantially vertical blade section 31. The rotor blades 29 define a V-shape in the vertical plane such that in use the rotation of the rotor 27 defines a shape or volume that substantially complements the shape of the lower conical section 25. That is, when the rotor 27 rotates about the drive shaft 12, it defines a substantially conical volume of revolution 32 to complement the shape of the lower conical section 25. This maximises the area of the separation chamber 23 above the vortex locating disc 28 that is subjected to the vortex 15, thus maximising separation of the feed liquid 3 into its froth and deaerated components. The shape of the lower conical section 25 also assists the creation of the vortex 15 due to its shape. The vortex locating disc 28 is positioned on the drive shaft 12 to limit the vortex 15 to substantially within the upper cylindrical section 24 and has a circular cross-sectional shape that to complement the circular cross-sectional shape of the upper cylindrical section of the separation chamber 23. In addition, the vortex locating disc 28 has a diameter that is less than the diameter of the rotor 27, as defused by the rotor blades 29.

The second embodiment of the invention works in substantially the same manner as is described in relation to the first embodiment of FIGS. 1 and 2. That is, aerated feed slurry 3 is gravity or pump fed into the separation chamber 23, preferably tangentially, via the feed conduit or inlet 2. The drive mechanism 13 and the drive shaft 12 rotate the rotor 27 so as to induce a rotational flow of the slurry 3 within the separation chamber 23 to develop a centrifugal vortex 15 initiating from the vortex locating disc 28. Due to the complementary shapes of the volume 32 and the lower conical section 25, the maximum amount of slurry is subjected to the rotation of the rotor 27, and therefore the rotational flow and vortex 15, thus enhancing the efficiency of the deaeration process. The vortex 15 separates the feed slurry 3 into the froth component 7 and the deaerated liquid or sludge component 8. The froth 7 migrates upwardly for removal through the upper outlet 9 as an overflow stream. The deaerated liquid or sludge 8 migrates downwardly for removal as an underflow stream through the lower side outlet 10, positioned at the bottom of the upper cylindrical section 24 above the conical section 25. A drain 33 removes any residual deaerated liquid or sludge 8 that is not captured by the lower side outlet 10 and is combined with the underflow stream before entering the thickener.

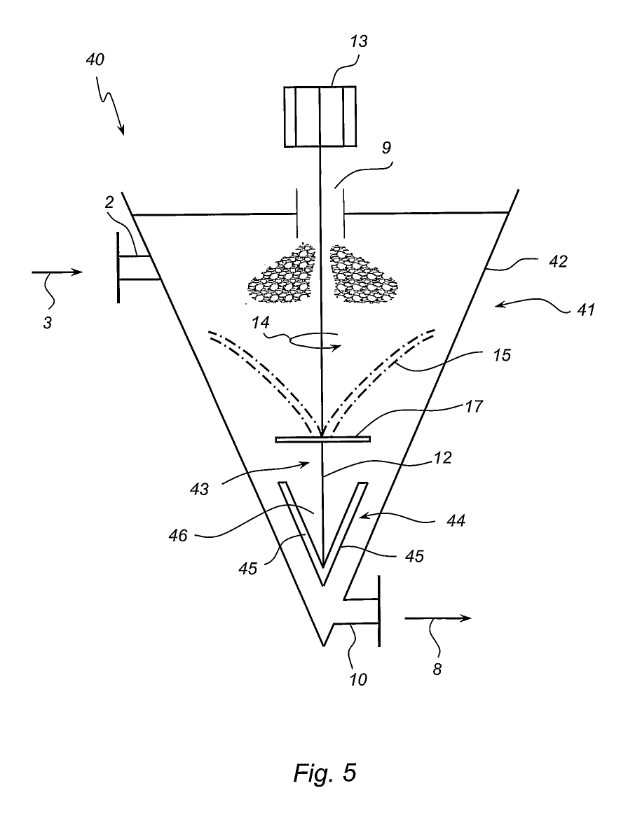

A third embodiment of the invention is illustrated in FIG. 5, where corresponding features have been given the same reference numerals. In this embodiment, the deaeration apparatus 40 has a separator 41 with substantially conical separation chamber 42 and a mechanical agitator 43. A rotor 44 has two linear rotor blades 45 that define a V-shape in the vertical plane that complements the vertical cross-section of the conical separation chamber 42. As in the second embodiment, when the rotor 44 rotates about the drive shaft 12, it defines a substantially conical volume of revolution 46 to complement the shape of the conical separation chamber 42, thus maximising the feed slurry that is subjected to the vortex 15 and consequently separation of the feed liquid 3 into its froth and deaerated components. The third embodiment operates in substantially the same manner as described in relation to the second embodiment of FIGS. 3 and 4, and thus it is not necessary to repeat the description of its operation.

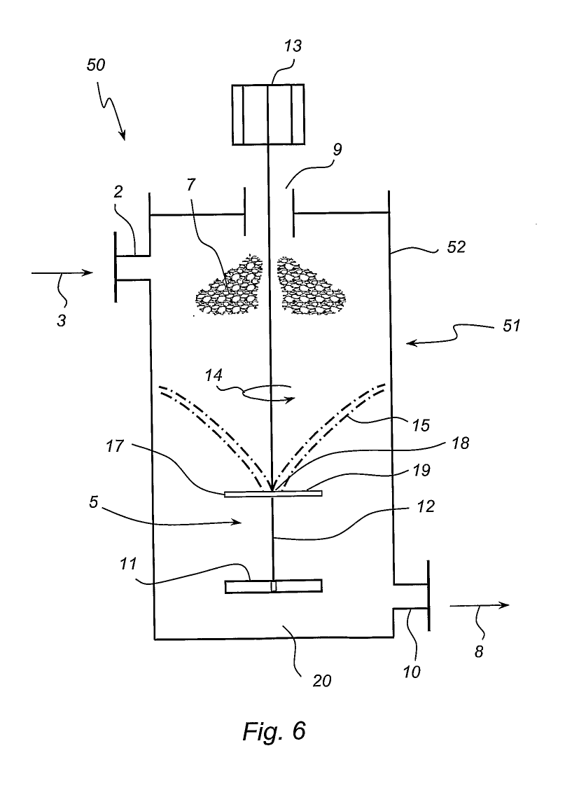

A fourth embodiment of the invention is illustrated in FIG. 6, where corresponding features have been given the same reference numerals. In this embodiment, the deaeration apparatus 50 has a separator 51 with substantially cylindrical separation chamber 52, instead of a frusto-conical chamber, and the mechanical agitator 5 of the first embodiment of the invention. In use, the rotor 11 defines, by way of its rotation, a cylindrical volume of revolution that complements the shape of the cylindrical separation chamber 52. This maximises the area of the separation chamber 52 above the vortex locating disc 17 that is subjected to the vortex 15, thus maximising separation of the feed liquid 3 into its froth and deaerated components. The third embodiment operates in substantially the same manner as described in relation to the first embodiment of FIGS. 1 and 2, and so a detailed description will not be repeated. However, due to the complementary shape of the volume defined by rotation of the rotor 11, more slurry 3 is subjected to the rotational flow, thus improving the efficiency of the deaeration process.

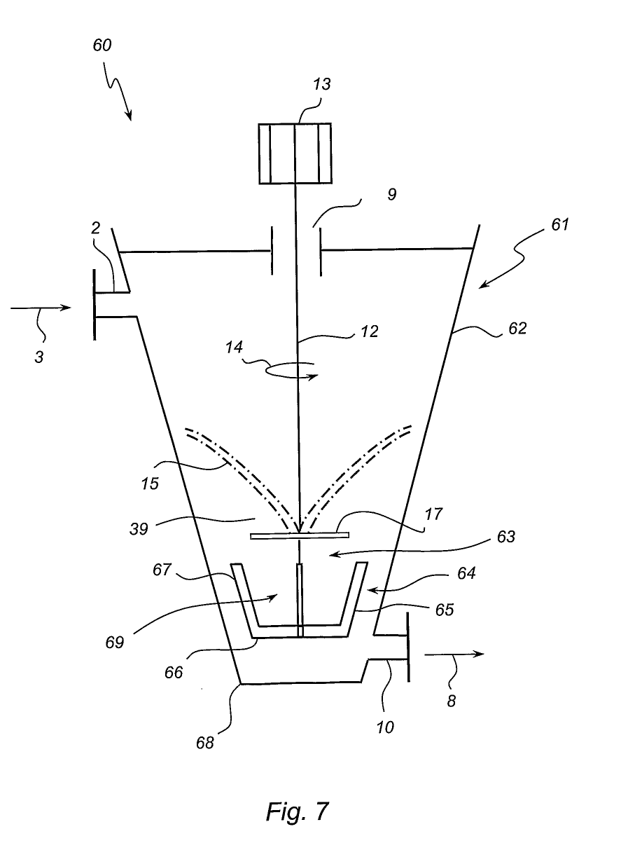

A fifth embodiment of the invention is illustrated in FIG. 7, where corresponding features have been given the same reference numerals. In this embodiment, the deaeration apparatus 60 has a separator 61 with a substantially frusto-conical separation chamber 62 and a mechanical agitator 63. A rotor 64 has four rotor blades 65, each with a substantially horizontal blade section 66 and an angular blade section 67. Each pair of diametrically opposing rotor blades 65 define two generally U-shapes in two vertical planes perpendicular to each other. The U-shapes complement the vertical cross-sectional shape of the bottom section 68 of the separation chamber 62, so that the rotor 64 defines a frusto-conical volume of revolution 69 that also complements the frusto-conical shape of the bottom section 68. Again, this increases the amount of slurry 3 that is subjected to the rotational flow and thus the deaeration process. A vortex locating device 17 is in the form of a substantially horizontal disc to complement the transverse cross-sectional shape of the separation chamber 62, as well as having a diameter less than the diameter of the rotor 64. The fifth embodiment operates in substantially the same manner as described in relation to the second embodiment of FIGS. 3 and 4, and thus it is not necessary to repeat the description of its operation.

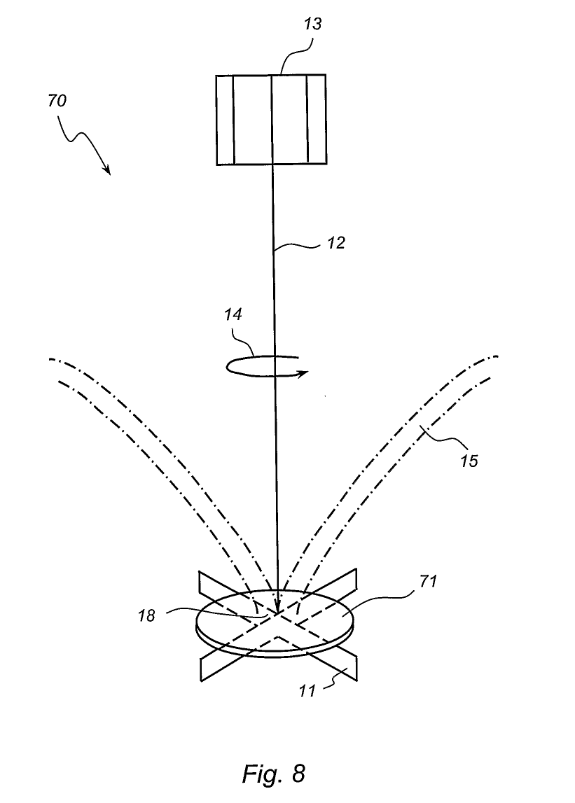

Referring to FIG. 8, a mechanical agitator 70 is illustrated for use with the embodiments of the invention, where corresponding features have been given the same reference numerals. In this embodiment of the mechanical agitator 70, the vortex locating device 71 is arranged at the base of the drive shaft 12 adjacent the rotor 11. This results in the maximum possible area of the separation chamber being used to generate the vortex 15 and thus minimise any “dead” areas of slurry 3 that may be within the separation chamber. This configuration of the mechanical agitator is applicable to the apparatuses previously described in relation to FIGS. 1, 3, 5, 6 and 7, but is particularly useful for the deaeration apparatuses of FIGS. 1 and 6.

In the preferred embodiments of the invention, the underflow stream from the lower outlet 10 feeds the deaerated liquid or sludge from the centrifugal separator 4, 22, 41, 51 and 61 to a thickener (not shown). This obviates the problem of accumulation of excess froth in the thickener and the associated feedwell, which in prior art devices significantly reduces the efficiency of the thickening process. The overflow stream from the upper outlet 9 is fed to a launder (not shown), where is can be broken down with fine water spray jets (not shown). This produces a third component consisting essentially of liquid from the spray jets mixed with the liquid from the collapsed froth, which may be combined with the underflow liquid downstream of the centrifugal separator and thence fed to the thickener, or else recycled to the feed liquid upstream of the centrifugal separator.

Whilst a single separator is illustrated in the preferred embodiments, it will be appreciated that a plurality of separators connected in series, parallel or a combination of both, may also be used depending upon the throughput, the degree of separation required, and other variables. However, it is preferred that the separator is upscaled in capacity to meet the required throughput of feed liquid that needs to be processed.

Of course, the centrifugal separator arrangement need not necessarily be applied only to thickeners, since the principle of deaeration performed by the centrifugal separators may be used in numerous other applications. There is also no specific requirement to recombine the overflow from the centrifugal separator with the underflow or with the feed material. The separated streams may simply be directed to discrete downstream process units as required.

In other embodiments, the position of the vortex locating device is adjustable upwardly or downwardly on the drive shaft. This additionally provides more control of the location of the vortex within the separation chamber and allows the amount of deaeration to be controlled within the apparatus, in conjunction with other operational parameters. Other embodiments use vortex locating devices of differing shapes, such as square, rectangular, triangular or other polygonal shapes. While the preferred embodiments of the invention have been described using vortex locating devices having a diameter equal to or less than the diameter of the rotor, vortex locating devices having diameters greater than the rotor diameter can also be used.

One skilled in the art will appreciate that the rotor configuration can be varied according to the shape of the separation chamber and is not limited to the configurations illustrated in the described embodiments.

It will also be appreciated by one skilled in the art that the invention provides a useful apparatus for mechanically deaerating liquids, especially liquid suspensions or pulps, thus reducing or substantially eliminating the harmful effects of froth in the subsequent separation processes conducted downstream of the deaeration apparatus.

Moreover, the illustrated deaeration apparatuses according to embodiments of the invention avoid the operational restrictions and additional expense involved with the installation and maintenance of the cyclonic-type centrifugal separators in the prior art. Consequently, the invention permits the deaeration apparatus to be scaled up to increase its capacity without requiring significant power to generate the centrifugal force required in cyclonic separators. For example, where five cyclonic centrifugal separator units would have been required to process 400 m³ of feed slurry, only a single deaeration apparatus according to the invention needs to be installed. In addition, the invention permits a simple means of feeding of the feed liquid or slurry by gravity, rendering it compatible with the majority of separation devices and facilitating retrofitting to existing plants and avoiding the use of pumps. Consequently, maintenance and installation costs for the deaeration apparatus are significantly less than the associated installation and maintenance cost for a comparable cyclonic separator unit. The increased capacity of the deaeration apparatus of the invention, coupled with its lower installation and maintenance costs, results in improved production efficiency in separation devices employing such apparatuses. In all these respects, the invention represents a practical and commercially significant improvement over the prior art.

Although the invention has been described with reference to specific examples, it will be appreciated by those skilled in the art that the invention may be embodied in many other forms.

1. An apparatus for deaerating a feed liquid comprising a liquid suspension or pulp, the apparatus comprising a feed conduit to convey the feed liquid into a separator, the separator comprising a mechanical agitator for inducing a rotational flow of the feed liquid in a separation chamber, such that the rotational flow generates a centrifugal vortex to separate the feed liquid into a first component consisting essentially of froth or gas and a second component consisting essentially of deaerated liquid or sludge, the separator further comprising a device for controlling the location of the vortex in the separation chamber.

2. The apparatus of claim 1, wherein the vortex locating device controls a start point of the vortex.

3. The apparatus of claim 1 or 2, wherein the position of the vortex locating device is adjustable.

4. The apparatus of any one of claims 1 to 3, wherein the vortex locating device has a shape such that its transverse cross-section complements the cross-sectional shape of the separation chamber.

5. The apparatus of any one of claims 1 to 4, wherein the vortex locating device is substantially circular or is a substantially horizontal circular disc.

6. The apparatus of any one of claims 1 to 5, wherein the mechanical agitator comprises a rotor mounted to a drive shaft and a drive mechanism for rotating the drive shaft so that the rotor induces the rotational flow in the separation chamber.

7. The apparatus of claim 6, wherein the vortex locating device axially displaces a start point of the vortex from the rotor.

8. The apparatus of claim 6 or 7, wherein the vortex locating device is provided adjacent or on the drive shaft.

9. The apparatus of any one of claims 6 to 8, wherein the vortex locating device extends substantially perpendicular to the drive shaft.

10. The apparatus of any one of claims 6 to 9, wherein the vortex locating device has a diameter equal to or less than the diameter of the rotor.

11. The apparatus of any one of claims 6 to 10, wherein the rotation of the rotor defines a shape that substantially complements the cross-sectional shape of the separation chamber.

12. The apparatus of any one of claims 6 to 11, wherein the rotor comprises a plurality of rotor blades, the rotor blades being equidistant to each other.

13. The apparatus of any one of claims 6 to 11, wherein the rotor comprises a plurality of rotor blades, the rotor blades extending substantially horizontally and vertically in the separation chamber.

14. The apparatus of claim 13, wherein the rotor blades define at least one V-shape or U-shape in the vertical plane.

15. The apparatus of claim 13 or 14, wherein the rotor blades define at least an X-shape in the horizontal plane.

16. The apparatus of any one of claims 1 to 15, wherein the separation chamber is substantially frusto-conical in shape, cylindrical in shape or is partly conical and partly cylindrical in shape.

17. The apparatus of any one of claims 1 to 16, wherein the feed conduit is configured to permit a gravity feed of the feed liquid.

18. The apparatus of any one of claims 1 to 17, wherein the second component leaves the separator as an underflow stream that is directed as a feed stream into a separation device.

19. A method for deaerating a feed liquid comprising a liquid suspension or pulp, the method comprising the steps of conveying the feed liquid into a separation chamber, mechanically agitating the feed liquid to induce a rotational flow, such that the rotational flow generates a centrifugal vortex to separate the feed liquid into a first component consisting essentially of froth or gas and a second component consisting essentially of deaerated liquid or sludge, and controlling the location of the vortex in the separation chamber with a vortex locating device.

20. The method of claim 19, wherein the vortex locating step comprises controlling a start point of the vortex.

21. The method of claim 19 or 20, wherein the vortex locating step comprises adjusting the position of the vortex locating device.

22. The method of any one of claims 19 to 22, further comprising the step of forming the vortex locating device such that its transverse cross-section complements the cross-sectional shape of the separation chamber.

23. The method of any one of claims 19 to 23, wherein the vortex locating device is substantially circular in shape or is a substantially horizontal circular disc.

24. The method of any one of claims 19 to 23, wherein the mechanical agitating step comprises rotating a rotor about a drive shaft to induce the rotational flow of the feed liquid.

25. The method of claim 24, wherein the vortex locating step comprises axially displacing a start point of the vortex from the rotor.

26. The method of claim 24 or 25, wherein the vortex locating step comprises locating a start point of the vortex adjacent or on the drive shaft.

27. The method of any one of claims 24 to 26, further comprising the step of forming the rotor such that rotation of the rotor defines a shape that substantially complements the shape of the separation chamber.

28. The method of any one of claims 19 to 27, wherein the feeding step comprises feeding the feed liquid under gravity into the separation chamber.

29. The method of any one of claims 19 to 28, further comprising the steps of removing the first component as an overflow stream, removing the second component as an underflow stream and directing the overflow and underflow streams to separate downstream process units.

30. The method of any one of claims 19 to 28, further comprising the steps of removing the second component as an underflow stream and directing the underflow stream into a separation device.

31. An apparatus or method for deaerating a feed liquid comprising a liquid suspension or pulp, substantially as herein described with reference to the drawings and/or examples.
